(19) United States
(12) Patent Application Publication
(10) Pub. No.: US 2007/0159947 A1
(43) Pub. Date: Jul. 12, 2007

(54) Optical recording apparatus, optical recording method and optical storage medium

(75) Inventor: Ikuo Matsumoto, Yokohama-Shi (JP)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: Victor Company of Japan, Ltd. a corporation of Japan, Yokohama-shi (JP)

(21) Appl. No.: 11/650,680

(22) Filed: Jan. 8, 2007

(30) Foreign Application Priority Data
Jan. 10, 2006 (JP) 2006-002423
Oct. 20, 2006 (JP) 2006-286011
Nov. 28, 2006 (JP) 2006-319685

(51) Int. Cl. G11B 20/10

(52) U.S. Cl. 369/59.19

(57) ABSTRACT

First identification data and second identification data are read out from a phase-change optical storage medium having a light-incident surface through which a light beam is to be incident and at least a first film-laminated layer structure and a second film-laminated layer structure provided over the surface in which the first structure is provided as closer to the surface than the second structure is. Each structure has at least a recording film. The data indicates first recording requirements to the first structure. The second data indicates second recording requirements to the second structure. The first and second requirements are different from each other. Given data to be recorded is modulated into modulated data. A data-recording signal having at least one mark followed by a space is generated based on the modulated data. The mark has a mark length nT (“T” being a unit dock cycle, and “n” being a positive integer of 3 or larger but 14 or smaller). Recording is controlled as to whether to record the data to the first or the second structure based on the first and second data. A first recording pulse sequence is generated based on the first requirements when the controller controls recording so that the data is recorded to the first structure. A second recording pulse sequence is generated based on the second requirements when the controller controls recording so that the data is recorded to the second structure. The first sequence has an (n−1)-number of recording pulses with a power corresponding to the mark length nT and additional pulses with a power that are generated for a period of the space and follow the recording pulses. The second sequence has an n/2-number of recording pulses with a corresponding to the mark length nT when “n” is an even number whereas having an (n−1)/2-number of recording pulses with a power corresponding to the mark length nT when “n” is an odd number. The data is recorded to the first and second structures with the light beam driven with the first and second sequences, respectively.

### CROSS-REFERENCE TO RELATED APPLICATIONS

This application is based on and claims the benefit of priority from the prior Japanese Patent Application No. 2006-002423 filed on Jan. 10, 2006, No. 2006-286011 filed on Oct. 20, 2006, and No. 2006-319685 filed on Nov. 28, 2006, the entire contents of which are incorporated herein by reference.

### BACKGROUND OF THE INVENTION

The present invention relates to an optical storage medium in which data is recorded with irradiation of a light beam (for example, a laser beam), and also an optical recording method and apparatus for such an optical storage medium.

Phase-change optical storage media are data-rewritable storage media utilizing a reversible phase change phenomenon between a crystalline phase and an amorphous phase, such as, recent CD-RW (rewritable compact disc), DVD-RW (rewritable digital versatile disc) and DVD-RAM (rewritable random-access digital versatile disc). Especially, DVD-RW and DVD-RAM are used for recording or rewriting a large amount of data, such as video data. What are required for phase-change optical storage media now increasingly popular for video recorders, personal computers, etc., are larger storage capacity and higher-density recordability for longer-time recording and storage of a larger amount of data, in addition to higher recording and overwrite characteristics.

One type of optical storage media developed for larger storage capacity is a dual-layer phase-change optical storage medium having two film-laminated layer structures each having, at least, a recording film. This type of storage media is used for stationary or home-use equipment such as video recorders and also potable equipment such as personal computers and camera-equipped optical recording apparatuses.

Dual-layer phase-change optical storage media have a first film-laminated layer structure L0 and a second film-laminated layer structure L1 stacked in order on a light-incident side of the storage medium through which a laser beam is incident in recording, reproduction or erasure. The structure L0 is located closer to the light-incident side than the structure L1 is.

One requirement for the first film-laminated layer structure L0 is that the structure L0 allow a laser beam to pass therethrough in recording to or reproduction from the second film-laminated layer structure L1. To meet this requirement, a recording film, a reflective film, etc., that constitute the structure L0 have to be made thinner for higher transmittance.

In contrast, the second film-laminated layer structure L1 located away from the light-incident side is not required to pass a laser beam therethrough to further away from the side. This allows a recording film, a reflective film, etc., that constitute the structure L1 to be made thicker for necessary characteristics.

Thinner films for the first film-laminated layer structure L0, however, achieve transmittance of more or less 50% to a laser beam to pass therethrough. Such transmittance requires a large laser power to cover losses due to absorption and reflection at the structure L0. In other words, the second film-laminated layer structure L1 requires a larger recording laser power than the structure L0.

Stationary optical recording apparatuses are fairly available to such a larger recording laser power to the second film-laminated layer structure L1. On the contrary, battery-powered portable optical recording apparatuses require a lower recording laser power to the structure L1 for lower power consumption.

Compact camera-equipped optical recording apparatuses use 8-cm-diameter low-capacity optical storage media. Such media should be a dual-layer phase-change type. However, as discussed above, the second film-laminated layer structure L1 of this type requires a larger recording laser power. Therefore, the dual-layer phase-change optical storage media are not useful for the compact battery-powered camera-equipped optical recording apparatuses.

### SUMMARY OF THE INVENTION

A purpose of the present invention is to provide an optical recording apparatus, an optical recording method, and an optical storage medium, available to a lower recording laser power to the film-laminated layer structure located farthest from the light-incident side of the storage medium having a plurality of film-laminated layer structures.

Another purpose of the present invention is to provide an optical recording apparatus, an optical recording method, and an optical storage medium, available not only to a lower recording laser power to the farthest film-laminated layer structure but also a normal recording laser power higher than the lower power.

The present invention provides an optical recording apparatus comprising: a reproducer to read out first identification data and second identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating first recording requirements to the first film-laminated layer structure, and the second identification data indicating second recording requirements to the second film-laminated layer structure, the first and second recording requirements being different from each other; an encoder to modulate given data to be recorded into modulated data; a recording signal generator to generate a data-recording signal having at least one mark followed by a space, based on the modulated data, the mark having a mark length nT (“T” being a unit clock cycle, and “n” being a positive integer of 3 or larger but 14 or smaller); a controller to control recording as to whether to record the data to be recorded to the first or the second film-laminated layer structure based on the read-out identification data; a recording pulse sequence generator to generate a first recording pulse sequence based on the first recording requirements when the controller controls recording so that the data is recorded to the first film-laminated layer structure whereas to generate a second recording pulse sequence based on the second recording requirements when the controller controls recording so that the data is recorded to the second film-laminated layer structure, the first recording pulse sequence having an (n−1)-number of recording pulses with a recording power corresponding to the mark length nT and additional pulses with a recording power that are generated for a period of the space and follow the recording pulses, and the second recording pulse sequence having an n/2-number of recording pulses with a recording power corresponding to the mark length nT when “n” is an even number whereas having an (n−1)/2-number of recording pulses with a recording power corresponding to the mark length nT when “n” is an odd number; and a recorder to record the data to the first and second film-laminated layer structures with the light beam driven with the first and second recording pulse sequences, respectively.

Moreover, the present invention provides an optical recording apparatus comprising: a reproducer to read out first identification data, second identification data and third identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating first recording requirements to the first film-laminated layer structure, the second identification data indicating second recording requirements to the second film-laminated layer structure, and the third identification data indicating third recording requirements to the second film-laminated layer structure, the first, second and third recording requirements being different from one another; an encoder to modulate given data to be recorded into modulated data; a recording signal generator to generate a data-recording signal having at least one mark followed by a space, based on the modulated data, the mark having a mark length nT (“T” being a unit dock cycle, and “n” being a positive integer of 3 or larger but 14 or smaller); a controller to control recording as to whether to record the data to be recorded to the first or the second film-laminated layer structure based on the read-out identification data; a recording pulse sequence generator to generate a first recording pulse sequence based on the first recording requirements when the controller controls recording so that the data is recorded to the first film-laminated layer structure whereas to generate the first recording pulse sequence or a third recording pulse sequence based on the third recording requirements, with no reference to the second recording requirements, when the controller controls recording so that the data is recorded to the second film-laminated layer structure, the first recording pulse sequence having an (n−1)-number of recording pulses with a recording power corresponding to the mark length nT and additional pulses with a recording power that are generated for a period of the space and follow the recording pulses, and the third recording pulse sequence having the (n−1)-number of recording pulses with a recording power corresponding to the mark length nT; and a recorder to record the data to the first film-laminated layer structure with the light beam driven with the first recording pulse sequence and to the second film-laminated layer structure with the light beam driven with the first or the third recording pulse sequence.

Furthermore, the present invention provides an optical recording method comprising the steps of: reading out first identification data and second identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating first recording requirements to the first film-laminated layer structure, and the second identification data indicating second recording requirements to the second film-laminated layer structure, the first and second recording requirements being different from each other; modulating given data to be recorded into modulated data; generating a data-recording signal having at least one mark followed by a space, based on the modulated data, the mark having a mark length nT (“T” being a unit clock cycle, and “n” being a positive integer of 3 or larger but 14 or smaller); controlling recording as to whether to record the data to be recorded to the first or the second film-laminated layer structure based on the read-out identification data; generating a first recording pulse sequence based on the first recording requirements when recording is controlled so that the data is recorded to the first film-laminated layer structure whereas generating a second recording pulse sequence based on the second recording requirements when recording is controlled so that the data is recorded to the second film-laminated layer structure, the first recording pulse sequence having an (n−1)-number of recording pulses with a recording power corresponding to the mark length nT and additional pulses with a recording power that are generated for a period of the space and follow the recording pulses, and the second recording pulse sequence having an n/2-number of recording pulses with a recording power corresponding to the mark length nT when “n” is an even number whereas having an (n−1)/2-number of recording pulses with a recording power corresponding to the mark length nT when “n” is an odd number; and recording the data to the first and second film-laminated layer structures with the light beam driven with the first and second recording pulse sequences, respectively.

Moreover, the present invention provides an optical recording method comprising the steps of: reading out first identification data, second identification data and third identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating first recording requirements to the first film-laminated layer structure, the second identification data indicating second recording requirements to the second film-laminated layer structure, and the third identification data indicating third recording requirements to the second film-laminated layer structure, the first, second and third recording requirements being different from one another; modulating given data to be recorded into modulated data; generating a data-recording signal having at least one mark followed by a space, based on the modulated data, the mark having a mark length nT (“T” being a unit clock cycle, and “n” being a positive integer of 3 or larger but 14 or smaller); controlling recording as to whether to record the data to be recorded to the first or the second film-laminated layer structure based on the read-out identification data; generating a first recording pulse sequence based on the first recording requirements when recording is controlled so that the data is recorded to the first film-laminated layer structure whereas generating the first recording pulse sequence or a third recording pulse sequence based on the third recording requirements, with no reference to the second recording requirements, when recording is controlled so that the data is recorded to the second film-laminated layer structure, the first recording pulse sequence having an (n−1)-number of recording pulses with a recording power corresponding to the mark length nT and additional pulses with a recording power that are generated for a period of the space and follow the recording pulses, and the third recording pulse sequence having the (n−1)-number of recording pulses with a recording power corresponding to the mark length nT; and recording the data to the first film-laminated layer structure with the light beam driven with the first recording pulse sequence and to the second film-laminated layer structure with the light beam driven with the first or the third recording pulse sequence.

Furthermore, the present invention provides a phase-change optical storage medium comprising: a light-incident surface through which a light beam is to be incident; at least a first film-laminated layer structure and a second film-laminated layer structure provided over the surface in which the first film-laminated layer structure is provided as closer to the light-incident surface than the second film-laminated layer structure is, each film-laminated layer structure having at least a recording film; and a storing area for physically storing first identification data indicating a first recording pulse sequence to be used in recording to the first film-laminated layer structure and second identification data indicating a second recording pulse sequence to be used in recording to the second film-laminated layer structure, the first recording pulse sequence having an (n−1)-number of recording pulses with a recording power corresponding to a mark length nT of a data-recording signal having at least one mark followed by a space, based on data to be stored, the mark having a mark length nT (“T” being a unit clock cycle, and “n” being a positive integer of 3 or larger but 14 or smaller) and additional pulses with a recording power that are generated for a period of the space and follow the recording pulses, and the second recording pulse sequence having an n/2-number of recording pulses with a recording power corresponding to the mark length nT when “n” is an even number whereas having an (n−1)/2-number of recording pulses with a recording power corresponding to the mark length nT when “n” is an odd number.

Still furthermore, the present invention provides an optical recording apparatus comprising: a reproducer to determine whether identification data is stored in a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the identification data indicating the optimum recording power of 35 mW or smaller to the second film-laminated layer structure, and read out the identification data if stored; and a controller to control recording to the phase-change optical storage medium so that data is recorded to the optical storage medium with the light beam driven with a power of 35 mW or smaller to the second film-laminated layer structure if the identification data is read out whereas the data is not recorded to the optical storage medium if the identification data is not stored.

Moreover, the present invention provides an optical recording apparatus comprising: a reproducer to read out first identification data or second identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating a first power of 35 mW or smaller as the optimum recording power to the second film-laminated layer structure, and the second identification data indicating a second power over 35 mW as the optimum recording power to the second film-laminated layer structure; and a controller to control recording to the phase-change optical storage medium so that data is recorded to the optical storage medium with the light beam driven with the first power to the second film-laminated layer structure if the first identification data is read out whereas with the second power to the second film-laminated layer structure if the second identification data is read out.

Furthermore, the present invention provides an optical recording method comprising the steps of: determining whether identification data is stored in a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the identification data indicating the optimum recording power of 35 mW or smaller to the second film-laminated layer structure, and reading out the identification data if stored; and controlling recording to the phase-change optical storage medium so that data is recorded to the optical storage medium with the light beam driven with a power of 35 mW or smaller to the second film-laminated layer structure if the identification data is read out whereas the data is not recorded to the optical storage medium if the identification data is not stored.

Moreover, the present invention provides an optical recording method comprising the steps of: reading out first identification data or second identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating a first power of 35 mW or smaller as the optimum recording power to the second film-laminated layer structure, and the second identification data indicating a second power over 35 mW as the optimum recording power to the second film-laminated layer structure; and controlling recording to the phase-change optical storage medium so that data is recorded to the optical storage medium with the light beam driven with the first power to the second film-laminated layer structure if the first identification data is read out whereas with the second power to the second film-laminated layer structure if the second identification data is read out.

Still furthermore, the present invention provides an phase-change optical storage medium comprising: a light-incident surface through which a light beam is to be incident; at least a first film-laminated layer structure and a second film-laminated layer structure provided over the surface in which the first film-laminated layer structure is provided as closer to the light-incident surface than the second film-laminated layer structure is, each film-laminated layer structure having at least a recording film; and a storing area for physically storing identification data indicating that the second film-laminated layer structure is available to recording with a recording power of 35 mW or smaller that is the optimum recording power to the second film-laminated layer structure.

### BRIEF DESCRIPTION OF DRAWINGS

FIG. 1 is a block diagram of an embodiment of an optical recording/reproduction apparatus according to the present invention;

FIG. 2 is a plan view illustrating an embodiment of an optical storage medium according to the present invention;

FIG. 3 is a vertical view illustrating a layered structure of the optical storage medium according to the present invention;

FIG. 4 is a view illustrating a first recording pulse sequence according to the present invention;

FIG. 5 is a view illustrating a second recording pulse sequence according to the present invention;

FIG. 6 is a view illustrating a third recording pulse sequence according to the present invention;

FIG. 7 is a table showing results of recording to sample optical storage media having the structure as shown in FIG. 3 with the recording pulse sequences shown in FIGS. 4 to 6;

FIG. 8 is an illustration of a variation to a lead-in area of the optical storage medium shown in FIG. 2;

FIG. 9 is an illustration of another variation to the lead-in area shown in FIG. 2;

FIG. 10 is a flow chart of an operation mode of a high-sensitivity optical recording apparatus that is a variation to the optical recording apparatus shown in FIG. 1;

FIG. 11 is a flow chart of an operation mode of a normal-sensitivity optical recording apparatus that is a variation to the optical recording apparatus shown in FIG. 1; and

FIG. 12 is a flow chart of an operation mode of a normal-sensitivity optical recording apparatus that is another variation to the optical recording apparatus shown in FIG. 1.

### DETAILED DESCRIPTION OF PREFERRED EMBODIMENTS

Several preferred embodiments according to the present invention will be disclosed with reference the attached drawings.

[Optical Recording/Reproduction Apparatus]

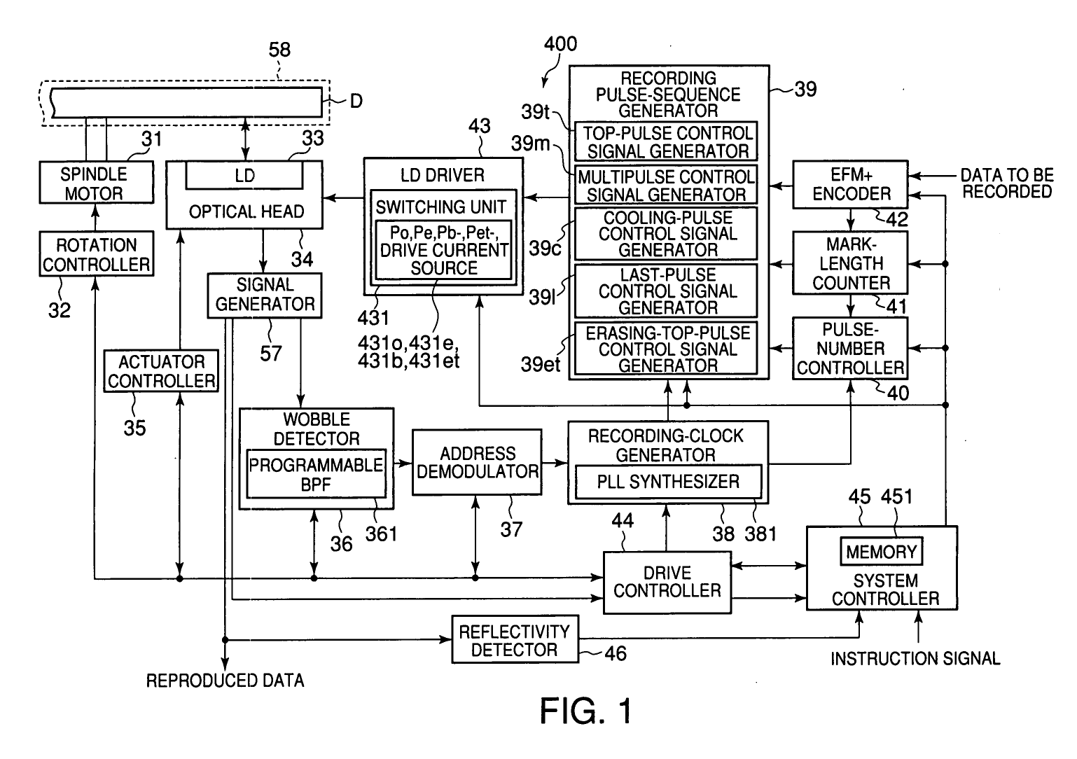

FIG. 1 shows an embodiment of an optical recording/reproduction apparatus according to the present invention.

An optical storage medium D is rotated by a spindle motor 31. The spindle motor 31 is controlled by a rotation controller 32 so that its rotating speed reaches a recording linear velocity corresponding to a target recording speed. Provided as movable in the radius direction of the optical storage medium D is an optical head 34 equipped with a semiconductor laser (LD) 33 for use in recording, reproduction or erasing, an objective lens (not shown) for focusing a laser beam from the LD 33, and a quadrant photo-detector (not shown).

A recommendable light source for the optical recording/reproduction apparatus of this embodiment is a high-intensity light source of a laser beam or strobe light, for example. The most recommendable is a semiconductor laser for compactness, low power consumption and easiness in modulation.

The quadrant photo-detector of the optical head 34 receives a beam reflected from the optical storage medium D while the medium D is irradiated with the laser beam from the LD 33. A signal based on the reflected beam is supplied to a signal generator 57 that produces a radial push-pull signal, a focus error signal, a tracking error signal, and a reproduced signal (RF signal) that is a composite signal from the quadrant photo-detector. The radial push-pull signal is supplied to a wobble detector 36. The focus and tracking error signals are supplied to a drive controller 44. The RF signal is supplied to the drive controller 44 and a reflectivity detector 46.

The drive controller 44 controls an actuator controller 35 based on the supplied focus and tracking error signals. The actuator controller 35 controls the optical head 34 in focusing and tracking to the optical storage medium D. Also controlled by the drive controller 44 are a rotation controller 32, a wobble detector 36, an address demodulator 37, and a recording-clock generator 38, which will be discussed later. The drive controller 44 and other several units are under control by a system controller 45, which will be discussed later.

The wobble detector 36, equipped with a programmable band-pass filter (BPF) 361, detects a wobble signal from wobbling tracks on the optical storage medium D and sends it to the address demodulator 37. The address demodulator 37 demodulates the wobble signal and outputs address data. The address data is supplied to a recording-clock generator 38, equipped with a PLL synthesizer 381, which generates recording-channel clocks and outputs them to a recording pulse-sequence generator unit 39 and a pulse-number controller 40.

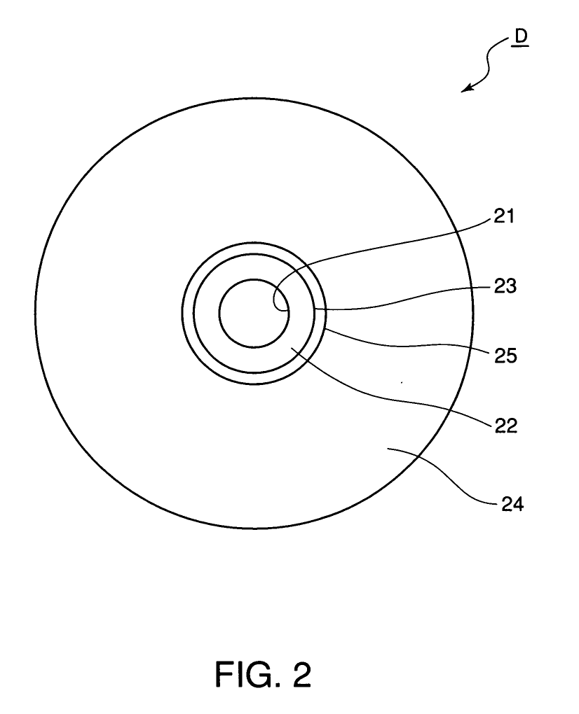

FIG. 2 is a plan view illustrating an embodiment of the optical storage medium D for use in the optical recording/reproduction apparatus, according to the present invention;

The optical storage medium D has a center hole 21 and a clamp area 22 therearound. Provided concentrically around the clamp area 22 are a data area (lead-in area) 23 and an optimum power control zone 25 (OPC zone) provided around which is a recording area 24 that stores actual data to be recorded such as video data and audio data.

Stored in the lead-in area 23 in this embodiment are read-only identification data (disc assigned information) in a readably embossed state. Alternatively, high-frequency wobbles or bits can be formed in a laser guide groove for gaining tracking signals, as carrying read-only identification data.

The identification data recorded in the lead-in area 23 are several recording requirements (recording conditions), such as, data on recording pulse sequences to be used in forming recorded marks with recording parameters (recording requirements), such as, a recording laser intensity (recording power Po, erasing power Pe, etc.) and a laser applying time (pulse width). The recording pulse sequences and recording parameters will be discussed later in detail. The recording power Po in this embodiment is the optimum recording power to give the excellent recording characteristics to film-laminated layer structures of the optical storage medium D. The film-laminated layer structures will be described later in detail. The identification data may further include the type of the medium D, any information on a manufacturer of the medium D, the number of the layer structures in the medium D, etc.

Described next is the reproduction mechanism and operation of the optical recording/reproduction apparatus to the optical storage medium D.

In FIG. 1, the optical storage medium D having the recording area 24 (FIG. 2) with data recorded therein is installed in a disc tray 58. The spindle motor 31 is then controlled by the rotation controller 32 so that its rotating speed reaches a recording linear velocity corresponding to a target recording speed to the optical storage medium D.

The LD 33 of the optical head 34 emits a weak reproduction laser beam to the lead-in area 23 (FIG. 2) of the optical storage medium D. The quadrant photo-detector of the optical head 34 receives a beam reflected from the optical storage medium D while the medium D is irradiated with the laser beam from the LD 33. A signal based on the reflected beam is then supplied to the signal generator 57. The optical head 34 with the LD 33 and the quadrant photo-detector, and the signal generator 57 work as a reproducer for reproducing data from the optical storage medium D.

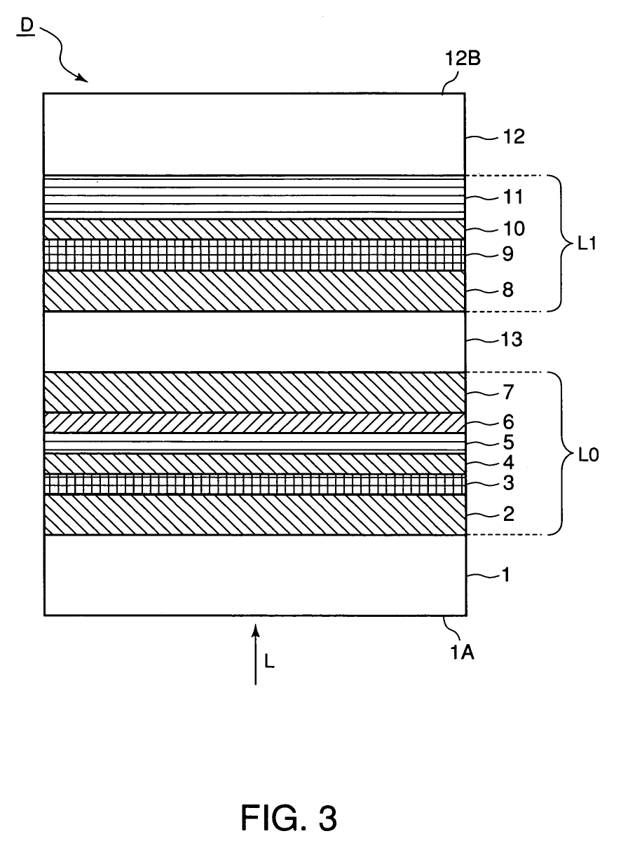

The signal generator 57 outputs a signal reproduced based on the reflected beam and supplies it to the reflectivity detector 46. The detector 46 detects a positive or a negative on the gradient of variation in reflectivity on the reflected beam to determine whether the beam is reflected from a first film-laminated layer structure L0 or a second film-laminated layer structure L1 of the optical storage medium D, which will be described later in detail with reference FIG. 3.

The optical head 34 is adjusted vertically so that a laser beam is focused onto a target recording film of the optical storage medium D.

Focusing and tracking to each recording film of the optical storage medium D is performed by the optical head 34 under control by the actuator controller 35 which works as a focus and tracking controller.

The optical head 34 outputs a signal based on the reflected beam from the recording area 24 of the optical storage medium D to the signal generator 57. The generator 57 produces an RF signal which is demodulated and output, through a demodulator (not shown), as a reproduced signal. The generator 57 also produces a radial push-pull signal which is then supplied to the wobble detector 36. The detector 36 detects a wobble signal and an LPP signal from the push-pull signal which are then supplied to the address demodulator 37. The demodulator 37 demodulates the LPP signal to gain address data which is then supplied to the drive controller 44.

Described next is the recording mechanism and operation of the optical recording/reproduction apparatus to the optical storage medium D.

In recording, the optical storage medium D having the recording area 24 with un-recorded regions is installed in the disc tray 58.

The LD 33 of the optical head 34 emits a weak reproduction laser beam to the lead-in area 23 of the optical storage medium D. The quadrant photo-detector of the optical head 34 receives a beam reflected from the optical storage medium D while the medium D is irradiated with the laser beam from the LD 33. A signal based on the reflected beam is then supplied to the signal generator 57. The generator 57 generates a signal reproduced based on the reflected beam and demodulate it to gain identification data which is then supplied to the system controller 45. The identification data carries recording pulse sequence data and recording parameters, as described above.

The system controller 45 writes the identification data in its memory 451, thus controlling the drive controller 44 based on the identification data. The drive controller 44 then controls the actuator controller 35, the wobble detector 36, and the address demodulator 37, under control by the system controller 45.

The system controller 45 controls or switches recording between the first film-laminated layer structure L0 and the second film-laminated layer structure L1 of the optical storage medium D. The reflectivity detector 46 then detects a positive or a negative on the gradient of variation in reflectivity on the reflected beam to determine whether the beam is reflected from the structure L0 or L1. The actuator controller 35 controls the optical head 34 for focusing and tracking to the recording-instructed layer structure.

The optical head 34 emits a recording laser beam to the optical storage medium D. The drive controller 44 outputs the wobble signal supplied from the wobble detector 36 to the recording-clock generator 38 and the address data from the address demodulator 37 to the system controller 45.

The demodulated address is supplied to the recording-clock generator 38, equipped with the PLL synthesizer 381, which generates recording-channel clocks and outputs them to the recording pulse-sequence generator unit 39 and the pulse-number controller 40.

The system controller 45 controls an EFM+encoder 42, a mark-length counter 41, and the pulse-number controller 40. It further controls the recording pulse-sequence generator unit 39 and an LD driver 43, based on the identification data, described above.

The EFM+encoder 42 modulates input data to be recorded into modulated data with 8-16 modulation and outputs it to the recording pulse-sequence generator unit 39 and the mark-length counter 41. The mark-length counter 41 counts intervals of inversion of the modulated data to generate mark-length data, the counted value being output to the generator unit 39 and the pulse-number controller 40. The counter 41 works as a producer to produce a data-recording signal that carries the data to be recorded. The data-recording signal has at least one mark with a given length and a space that follows the mark.

The controller 40 controls the recording pulse-sequence generator unit 39 to generate specific recording pulses based on the supplied counted value and recording-channel clocks.

The recording pulse-sequence generator unit 39 is equipped with a top-pulse control signal generator 39t, a multipulse control signal generator 39m, a last-pulse control signal generator 391, a cooling-pulse control signal generator 39c, and an erasing-top-pulse control signal generator 39et. The unit 39 generates several control signals for a recording pulse sequence based on the identification data. In detail, the generators 39t, 39m, 39c, 39l, and 39et generate a top-pulse control signal, a multipulse control signal, a cooling-pulse control signal, a last-pulse control signal, and an erasing-top-pulse control signal, respectively. Each control signal is supplied to the LD driver unit 43.

A switching unit 431 of the LD driver unit 43 switches a drive current source 431o for recording power Po, a drive current source 431e for erasing power Pe, a drive current source 431b for bottom power Pb, and a drive current source 431et for erasing top power Pet, based on the supplied control signals, thus generating a recording pulse sequence.

The Po-drive current source 4310, the Pe-drive current source 431e, the Pb-drive current source 431b, and the Pet-drive current source 431et supply currents to the optical head 34 based on a recording power Po, an erasing power Pe, a bottom power Pb, and an erasing top power Pet prestored in the memory 451 of the system controller 45. These four power levels are optimum levels to give the optical storage medium D excellent recording characteristics. Identification data that indicates these four power levels are read from the medium D and stored in the memory 451 which is a recordable RAM (Random Access Memory), for example.

The optical recording/reproduction apparatus in this embodiment can set any recording linear velocity selected among a plurality of recording linear velocities for higher linear velocity (×speed) in the optical storage medium D. On receiving an instruction signal for selecting a recording linear velocity (×speed mode), the system controller 45 controls the Po-drive current source 431o, the Pe-drive current source 431e, the Pb-drive current source 431b, and the Pet-drive current source 431et, as disclosed above, based on the identification data at an instructed recording linear velocity stored in the memory 451. Identification data at a plurality of recording linear velocities are stored in the memory 451, as disclosed above.

A generated recording pulse sequence is input to the optical head 34. The optical head 34 controls the LD 33 to output LD-emitted waveforms carrying a desired recording pulse sequence and power, thus recording data to the optical storage medium D.

The recording-pulse generator unit 39, the LD driver unit 43, and the optical head 34 work together as a recording unit 400 that generates a desired recording pulse sequence based on the identification data and the data-recording signal generated by the mark-length counter 41, and emits recording beams onto the optical storage medium D through the LD 33 in accordance with the desired recording pulse sequence, thus forming recorded marks indicating the data to be recorded.

This embodiment employs the EFM (Eight-to-Fourteen) modulation in generation of recorded mark data. Not only that, other modulation techniques, such as, 1-7 modulation, are applicable to the present invention.

Described next with reference to FIG. 3 is a layered structure of the optical storage medium D according to the present invention.

The optical storage medium D shown in FIG. 3 includes the first film-laminated layer structure L0 and the second film-laminated layer structure L1. The structure L0 is formed on a first substrate 1 having a bottom surface that is a light-incident surface 1A on which a laser beam is incident in a direction L. The structure L1 is formed on a second substrate 12 having a surface 12B for labeling. The structures L0 and L1 are bonded to each other with an adhesive layer 13.

The first film-laminated layer structure L0 has a structure in which a first protective film 2, a first recording film 3, a second protective film 4, a first reflective film 5, a high thermal conductive film 6 and a third protective film 7 are stacked in order on the first substrate 1 having the light-incident surface 1A on the opposite side.

The second film-laminated layer structure L1 has a structure in which a second reflective film 11, a fifth protective film 10, a second recording film 9, and a fourth protective film 8 are stacked in order on the second substrate 12 having the surface 12B for labeling on the opposite side.

Shown in FIG. 3 are the two film-laminated layer structures L0 and L1 (a dual-layer type). However, the optical storage medium D according to the present invention can be provided with one or more of film-laminated layer structures between the structures L0 and L1 (a multilayer type).

In the disclosure, the first and second film-laminated layer structures L0 and L1 are defined as below for the optical storage medium D which is the dual-layer type or the multilayer type.

The first film-laminated layer structure L0 is the layer structure located closer (the dual-layer type) or closest (the multilayer type) to the light-incident surface 1A of the first substrate 1. The structure L0 is a highly transparent film-laminated layer structure that allows a laser beam to pass therethrough in recording to or reproduction from the second film-laminated layer structure L1.

The second film-laminated layer structure L1 is the layer structure located farther (the dual-layer type) or farthest (the multilayer type) from the light-incident surface 1A of the first substrate 1.

The film-laminated layer structures L0 and L1 are referred to as the highly transparent layer structure L0 and the farther layer structure L1, respectively, in the following disclosure.

A sample optical storage medium D was produced as described below:

The first substrate 1 was made of a polycarbonate resin with 0.58 mm in thickness. A 66-nm-thick first protective film 2 was formed on the first substrate 1, with ZnS—SiO₂. Formed on the first protective film 2, in order, were a 7-nm-thick first recording film 3 with a target of an alloy of 4 elements Ag—In—Sb—Te, a 9 nm-thick second protective film 4 of the same material as the first protective film 2, a 5-nm-thick semi-transparent first reflective film 5 with a target of an Ag alloy, a 5-nm-thick high thermal conductive film 6 with Al—Nx (x: the degree of nitriding depending on the amount of nitrogen introduced), and a 56-nm-thick third protective film 7 of the same material as the first protective film 2, thus the highly transparent layer structure L0 being produced.

The second substrate 12 was made of the same material as the first substrate 1 but with 0.60 mm in thickness. Formed on the second substrate 12, in order, were an 80-nm-thick second reflective film 11 with a target of an Ag alloy, a 15-nm-thick fifth protective film 10 of the same material as the first protective film 2, a 20-nm-thick second recording film 9 with a target of an alloy of 4 elements Ag—In—Sb—Te, and a 66-nm-thick fourth protective film 8 of the same material as the first protective film 2, thus the farther layer structure L1 being produced.

The highly transparent layer structure L0 and the farther layer structure L1 are bonded to each other with the adhesive layer 13 provided between the third and fourth protective films 7 and 8, thus a dual-layer phase-change optical storage medium D being produced.

The adhesive layer 13 may be a UV-curable resin or double-sided sheet type. The first and second substrates 1 and 12 may have a diameter of 120 mm or 80 mm. The dual-layer phase-change optical storage medium D thus produced is available for recording at 2×speed.

[Optical Recording Method]

Battery-powered portable optical recording apparatuses require a lower recording laser power, as already discussed. The upper limits of the recording laser power that battery-powered portable and stationary optical recording apparatuses can withstand are defined as 35 mW and 45 mW, respectively, in the following disclosure.

Several identical sample optical storage media D produced as described were subjected to recording using several types of recording pulse sequences to evaluate the recording laser power to the farther layer structure L1.

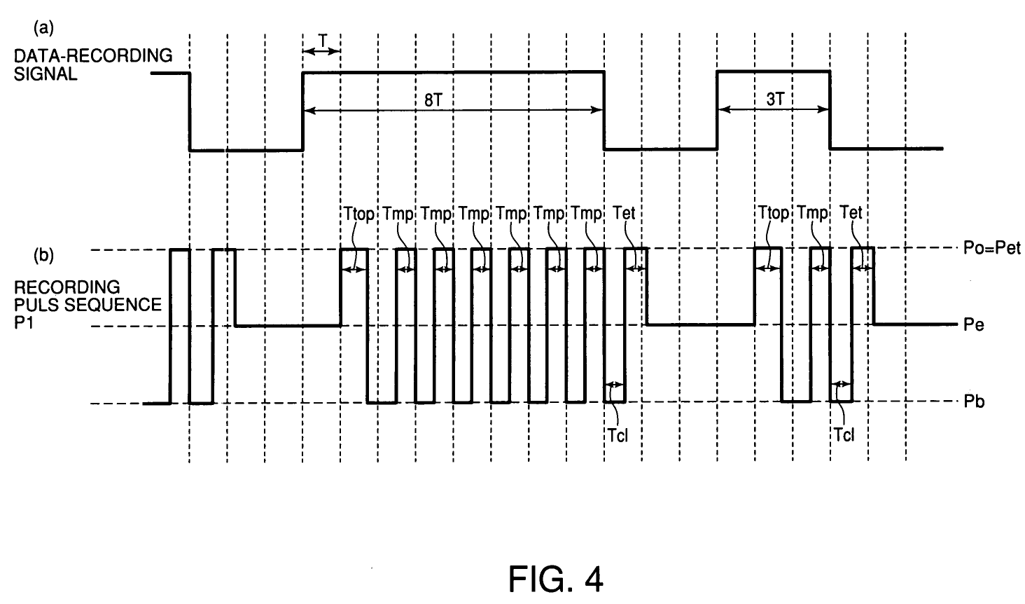

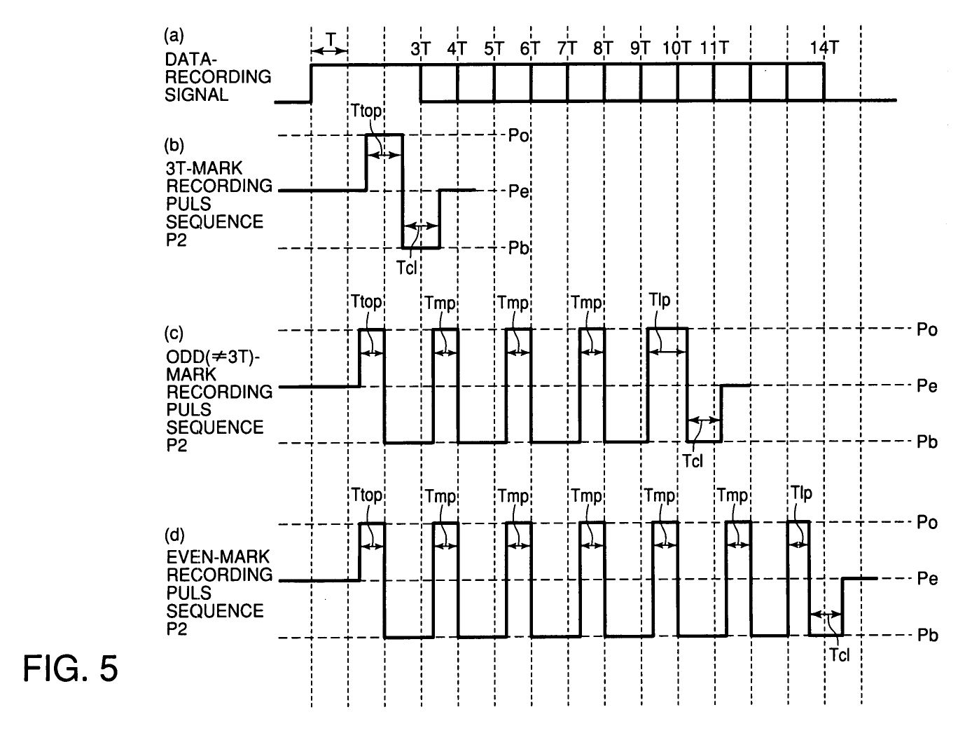

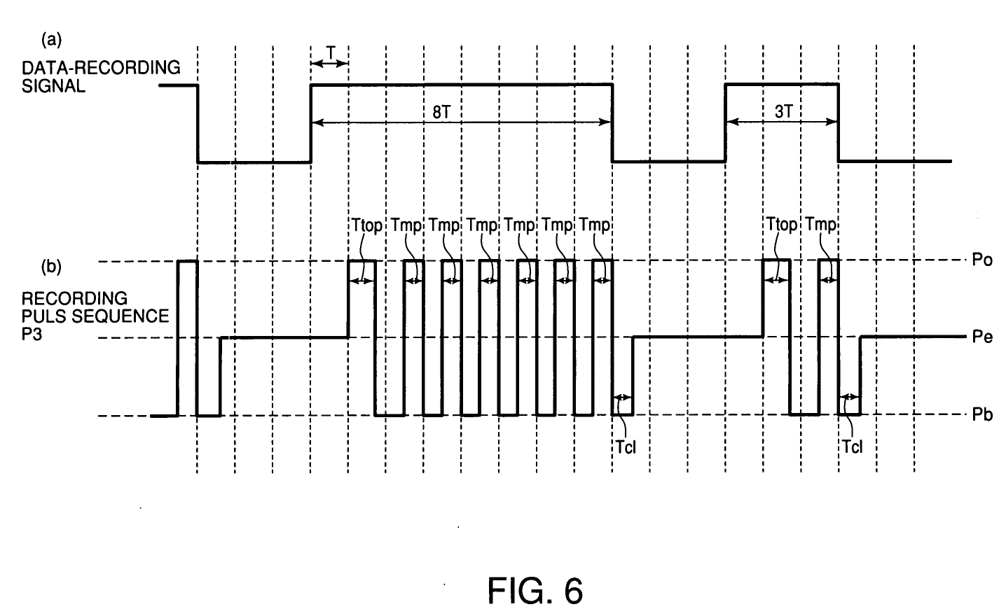

Used for recording were: a first recording pulse sequence P1 shown in FIG. 4 to the highly transparent layer structure L0; and the sequence P1, a second recording pulse sequence P2 shown in FIG. 5 or a third recording pulse sequence P3 shown in FIG. 6 to the farther layer structure L1.

Described next with reference to FIGS. 4 to 6 are data-recording signals to be used in forming marks and recording pulse sequences corresponding to such data-recording signals.

Shown in (a) and (b) of FIG. 4 are a data-recording signal to be used in forming 8T and 3T marks and the recording pulse sequence P1 corresponding to the data-recording signal.

The recording pulse sequence P1 shown in (b) of FIG. 4 consists of: a top pulse Ttop that raises a laser beam from an erasing power Pe to initially apply the laser beam onto a recording film with a recording power Po; multipulses Tmp that follow the top pulse Ttop, for alternatively applying the recording power Po and a bottom power Pb; a cooling pulse Tcl that raises the laser beam from the bottom power Pb to an erasing power Pe; and an erasing top pulse Tet that follows the cooling pulse Tcl, for applying an erasing top power Pet. The erasing top pulse Tet is the last pulse in the sequence P1 that corresponds to the end of each recorded mark. The recording power Po and the erasing top power Pet have the same laser power level in the sequence P1. The top pulse Ttop and the multipulses Tmp constitute heating pulses (recording pulses) for forming a recorded mark on a recording film.

The term “multipulse” is used for a single pulse Tmp or a plurality of pulses Tmp depending on a data-recording signal in the disclosure.

The recording pulse sequence P1 has a single multipulse Tmp for a period of 1T. Here, T indicates a unit clock cycle, 1T=38.2 ns at DVD×1 speed (disc rotation speed: 3.84 m/s), 1T=9.6 ns at DVD×4 speed (disc rotation speed: 15.4 m/s) for dual-layer DVD (the dual-layer phase-change optical storage medium D).

Recording to the optical storage medium D with the recording pulse sequence P1 is performed with modulation at four laser power levels (recording power Po, erasing power Pe, bottom power Pb, and erasing top power Pet) with increase or decrease in the numbers of multipulses Tmp depending on a mark length nT to be formed. For example, in DVD-RW, there are ten types of mark length nT, that is, 3T, 4T, 5T, 6T, 7T, 8T, 9T, 10T, 11T, and 14T.

The total number of the recording pulses (the top pulse Ttop and the multipulses Tmp) in the recording pulse sequence P1 for applying the recording power Po is (n−1) when a mark length is expressed as nT, as shown in (b) of FIG. 4. The other additional pulses that follow the recording pulses are generated for a period of a space that follows a mark, which is also true for other types of recording pulse sequence described below.

Shown in (a) of FIG. 5 is a data-recording signal to be used in forming 3T to 14T marks. Shown in (b), (c) and (d) of FIG. 5 are three types of the recording pulse sequence P2 for the 3T mark, 11T mark, and 14T mark, respectively. As shown, the recording pulse sequences P2 are different from one another depending on whether “n” in the mark length nT is an even or odd number.

Described first is that “n” is an odd number.

The first type of the recording pulse sequence P2 in (b) of FIG. 5 is used when “n” in the mark length nT is 3 (3T). It consists of: a top pulse Ttop that raises a laser beam from an erasing power Pe to initially apply the laser beam onto a recording film with a recording power Po; and a cooling pulse Tcl that follows the top pulse Ttop for applying the laser beam at a bottom power Pb and then an erasing power Pe.

The second type of the recording pulse sequence P2 in (c) of FIG. 5 is used when “n” in the mark length nT is an odd number larger than 3. It consists of: the top pulse Ttop; multipulses Tmp that follows the top pulse Ttop for alternatively applying the recording power Po and the bottom power Pb; a last pulse Tlp that raises a laser beam from the bottom power Pb to the recording power Po; and the cooling pulse Tcl.

The top pulse Ttop, the multipulses Tmp and the last pulse Tlp constitute recording pulses for forming a recorded mark on a recording film. The recording pulse sequence P2 in (b) of FIG. 5 has no multipulses Tmp and last pulse Tlp when “n” in the mark length nT is 3 and hence the top pulse Ttop only is a recording pulse. The total number of the top pulse Ttop, the multipulses Tmp and the last pulse Tlp is (n−1)/2 when “n” is an odd number.

Described next is that “n” is an even number.

The third type of the recording pulse sequence P2 in (d) of FIG. 5 is used when “n” in the mark length nT is an even number. It consists of the top pulse Ttop, the multipulses Tmp, the last pulse Tlp and the cooling pulse Tcl. The recording pulse is constituted by the top pulse Ttop, the multipulses Tmp and the last pulse Tlp. The total number of the top pulse Ttop, the multipulses Tmp and the last pulse Tlp is n/2 when “n” is an even number.

The recording pulse sequence P2 has a single multipulse Tmp for a period of 2T for 4T to 14T marks. The numbers of multipulses Tmp depends on a mark length nT to be formed. The numbers of pulses that constitute the recording pulses is the same when “n” in the mark length nT is “k” and “k+1” (n=4 and 5, 6 and 7, 8 and 9, and 10 and 11). A pulse applying period (pulse width) of the last pulse Tip is adjusted to give a heating period that corresponds to the mark length nT when “n” is “k” and “k+1”.

Shown in (a) and (b) of FIG. 6 are a data-recording signal to be used in forming 8T and 3T marks and the recording pulse sequence P3 corresponding to the data-recording signal.

The recording pulse sequence P3 shown in (b) of FIG. 6 consists of: a top pulse Ttop that raises a laser beam from an erasing power Pe to initially apply the laser beam onto a recording film with a recording power Po; multipulses Tmp that follow the top pulse Ttop, for alternatively applying the recording power Po and a bottom power Pb; and a cooling pulse Tcl that raises the laser beam from the bottom power Pb to an erasing power Pe. The cooling pulse Tcl is the last pulse in the sequence P3 that corresponds to the end of each recorded mark. The top pulse Ttop and the multipulses Tmp constitute recording pulses for forming a recorded mark on a recording film. The top pulse Ttop may only be a recording pulse.

The total number of the recording pulses (the top pulse Ttop and the multipulses Tmp) in the recording pulse sequence P3 is (n−1) when a mark length is expressed as nT. The recording pulse sequence P3 has a single multipulse Tmp for a period of 1T.

In each of the recording pulse sequences P1, P2 and P3, the laser power levels are adjusted as Po>Pe>Pb. The applying period (pulse width) of each laser power is set so that the optical storage medium D exhibits the excellent recording characteristics.

The recording pulse sequence P1 in (b) of FIG. 4 is identical to the recording pulse sequence P3 in (b) of FIG. 6 except that, in the former, the cooling pulse Tcl is followed by the erasing top pulse Tet that raises the laser beam to the erasing top power Pet and then lowers to the erasing power Pe. The recording pulse sequence P1 is suitable for recording to the highly transparent layer structure L0.

The three types of the recording pulse sequences P2 in (b) to (d) of FIG. 5 are advantageous over the recording pulse sequences P1 and P3 in suppressing increase in the recording power Po.

The recording pulse sequence P3 with no erasing top pulse Tet is advantageous over the recording pulse sequence P1 in suppressing the average level of laser power to a recording film.

Discussed below is evaluation of the recording laser power to several identical sample optical storage media D produced as described above.

(Sample D1)

A sample optical storage medium D1 was subjected to recording with the recording pulse sequences P1 and P2 to the highly transparent layer structure L0 and the farther layer structure L1, respectively, at 7.5 m/s in recording linear velocity (DVD×2 speed).

The sample D1 exhibited: 8.7% jitters to a recording power of 20 mW at the highly transparent layer structure L0; and 8.5% jitters to a recording power of 32 mW at the farther layer structure L1, with 55% in the degree of modulation (DM) at the structure L1 (50% or higher in DM feasible to meet the specifications).

The recording power of 20 mW is the optimum recording power Po0 to the sample D1 at which the highly transparent layer structure L0 exhibits the smallest jitters. Likewise, the recording power of 32 mW is the optimum recording power Po1 for the sample D1 at which the farther layer structure L1 exhibits the smallest jitters. The power ratio (Po1/Po0) is 1.6.

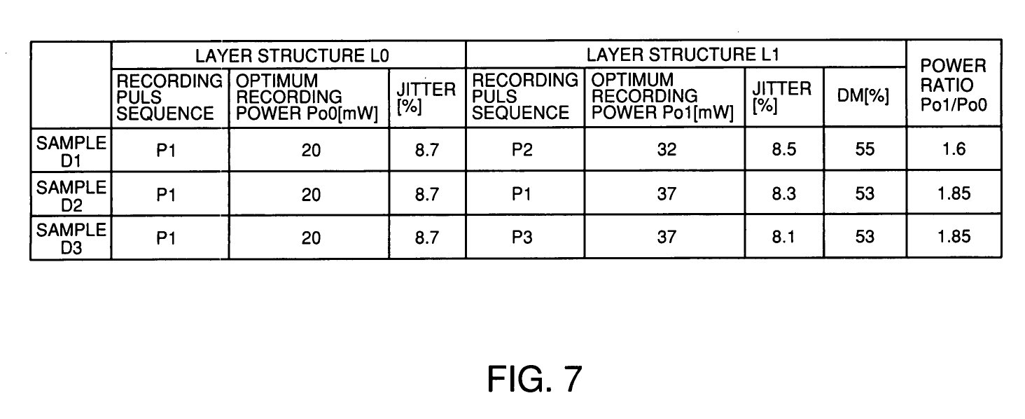

The results of the sample D1 are shown in FIG. 7 with those of samples D2 and D3 discussed below.

(Sample D2)

A sample optical storage medium D2 was subjected to recording with the recording pulse sequence P1 to both of the highly transparent layer structure L0 and the farther layer structure L1 at 7.5 m/s in recording linear velocity (DVD×2 speed).

The sample D2 exhibited: 8.7% jitters to the optimum recording power Po0 of 20 mW at the highly transparent layer structure L0; and 8.3% jitters to the optimum recording power Po1 of 37 mW at the farther layer structure L1 (Po1/Po0=1.85), with a feasible level of 53% in DM at the structure L1.

(Sample D3)

A sample optical storage medium D3 was subjected to recording with the recording pulse sequences P1 and P3 to the highly transparent layer structure L0 and the farther layer structure L1, respectively, at 7.5 m/s in recording linear velocity (DVD×2 speed).

The sample D3 exhibited: 8.7% jitters to the optimum recording power Po0 of 20 mW at the highly transparent layer structure L0; and 8.1% jitters to the optimum recording power Po1 of 37 mW at the farther layer structure L1 (Po1/Po0=1.85), with a feasible level of 53% in DM at the structure L1.

The results show that the recording pulse sequence P2 to the farther layer structure L1 requires lower optimum recording power Po1 in recording to the sample D1 than the samples D2 and D3 with the pulse sequence P1 and P3, respectively, to the structure L1.

Moreover, the results show that the recording strategy for the sample D1 applies the optimum recording power Po1 of 32 mW to the farther layer structure L1. This suggests that a 35-mW-maximum laser-power portable optical recording apparatus can give excellent recording characteristics to the optical storage medium D.

It is therefore preferable to employ a recording laser power of 35 mW or lower to the farther layer structure L1, which is referred to as a high-sensitivity optical recording method, hereinafter. This particular method requires a relatively lower laser power in recording to the structure L1 to give excellent recording characteristics to the optical storage medium D.

In contrast, stationary optical recording apparatus such as video recorders can apply a recording laser power that exceeds 35 mW, thus being able to employ a recording method using the optimum recording power Po1 of 37 mW to optical storage media, such as the samples D2 and D3.

Employing the first recording pulse sequence P1 to both of the highly transparent layer structure L0 and the farther layer structure L1, like applied to the sample D2, is preferable for easier design and control of optical recording apparatuses. Employing the different recording pulse sequences P1 and P3 to the structures L0 and L1, respectively, like applied to the sample D3, is preferable for easier control of optical recording apparatuses. This is because the difference between the sequences P1 and P3 is only that the former has the erasing top pulses Tet whereas the latter does not have such pulses. Moreover, the samples D2 and D3 exhibited excellent recording characteristics to the sequence P1 and the combination of the sequences P1 and P3, respectively, as shown in FIG. 7.

It is therefore available to employ a recording laser power that exceeds 35 mW to the farther layer structure L1 in stationary optical recording apparatuses, which is referred to as a normal-sensitivity optical recording method, hereinafter.

The stationary optical recording apparatus is referred to as a normal-sensitivity optical recording apparatus, hereinafter. The portable optical recording apparatus with a lower maximum laser power than the stationary type is referred to as a high-sensitivity optical recording apparatus only for highly-sensitive optical recording media, hereinafter. The highly-sensitive optical recording media will be described layer.

The high-sensitivity optical recording apparatus employs only the high-sensitivity optical recording method, defined as above. In contrast, the normal-sensitivity optical recording apparatus are divided into two types: one available only to the high-sensitivity method; the other available to both of the high-sensitivity and normal-sensitivity methods.

The structure of the optical storage media applicable to the high-sensitivity and/or the normal-sensitivity optical recording methods is not limited to the one having the highly transparent layer structure L0 and the farther layer structure L1, such as shown in FIG. 3, which exhibits excellent recording characteristics, such as the samples D1 to D3 when the methods are employed.

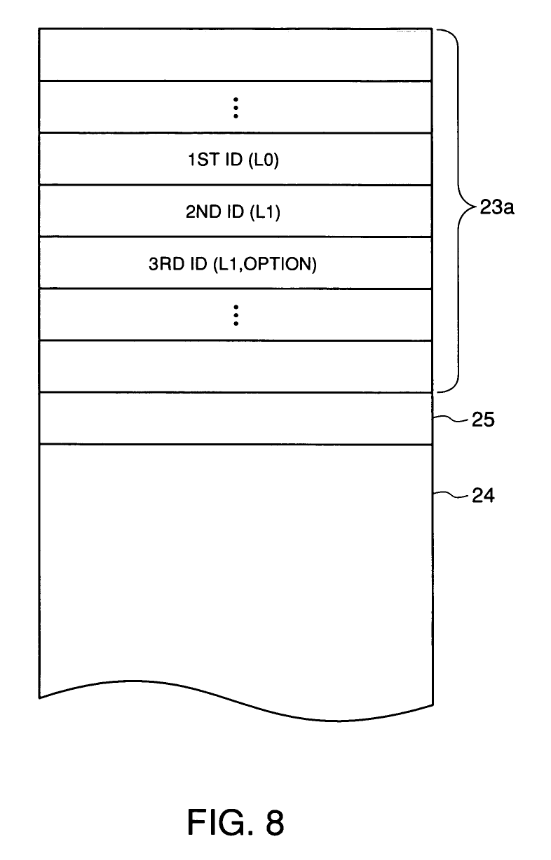

Illustrated in FIG. 8 is a lead-in area 23a, a variation to the lead-in area 23 (FIG. 2) of the optical storage medium D, followed by the OPC zone 25 and the recording area 24, to or from which recording or reproduction is performed by the optical recording/reproduction apparatus, according to the present invention.

Stored in the lead-in area 23a are:

first identification data (ID) that indicates first recording requirements to produce the first recording pulse sequence P1 for the highly transparent layer structure L0;

second identification data that indicates second recording requirements to produce the second recording pulse sequence P2 for the farther layer structure L1; and

third identification data that indicates third recording requirements to produce the first or the third recording pulse sequence P1 or P3 for the farther layer structure L1.

The first to third identification data are stored in the lead-in area 23a in a readably embossed state, which indicate recording parameters such as a recording laser intensity and a laser applying time, as described above. The first and second identification data are always stored whereas the third one is an option and depends on the recording requirements to the farther layer structure L1.

In recording to the optical storage medium D with the high-sensitivity (portable) optical recording apparatus, it is preferable to read the first and second identification data from the lead-in area 23a of the medium D and perform recording with the first recording pulse sequence P1 to the highly transparent layer structure L0 and the second recording pulse sequence P2 to the farther layer structure L1, based on the first and second identification data, respectively, with the high-sensitivity optical recording method.

In recording to the optical storage medium D with the normal-sensitivity (stationary) optical recording apparatus, it is preferable to read the first to third identification data from the lead-in area 23a of the medium D and perform recording with the first recording pulse sequence P1 to the highly transparent layer structure L0 and the first or the third recording pulse sequence P1 or P3 to the farther layer structure L1, based on the first and third identification data, respectively, (without reference to the second identification data), with the normal-sensitivity optical recording method.

As described above, the third identification data is an option for the recording requirements to the farther layer structure L1. In other words, the first and second identification data are fundamental data to be stored in the lead-in area 23a of the optical storage medium D for the high-sensitivity optical recording apparatus to provide excellent recording characteristics. Nevertheless, having the first, the second and the third identification data stored in the lead-in area 23a provides versatility between the high- and normal-sensitivity optical recording apparatuses for high-quality recording.

Newly defined in the following disclosure are a highly-sensitive optical storage medium Dh and a normally-sensitive optical storage medium Dl in the optical storage medium D according to the present invention. The storage medium Dh is produced with specific film compositions and/or layer structures for optimum recording with the high-sensitivity optical recording apparatus. The storage medium Dl is produced with specific film compositions and/or layer structures for optimum recording with the normal-sensitivity optical recording apparatus.

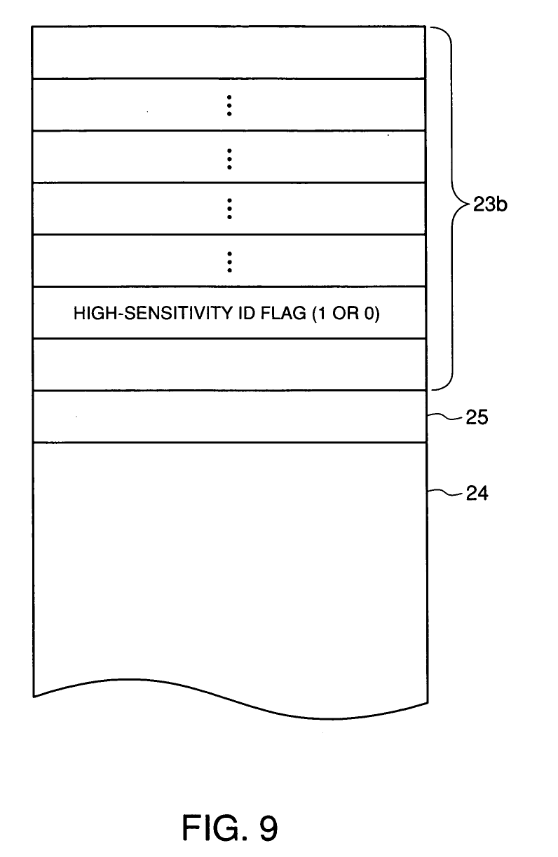

Illustrated in FIG. 9 is a lead-in area 23b, another variation to the lead-in area 23 (FIG. 2) of the optical storage medium Dh or Dl, followed by the OPC zone 25 and the recording area 24. Stored in the lead-in area 23b in a readably embossed state are the identification data described above together with a high-sensitivity identification (ID) flag.

The high-sensitivity identification flag is high-sensitivity identification data that identifies the farther layer structure L1 as a highly-sensitive film-laminated layer structure for which the optimum recording power Po1 is 35 mW or lower and which is available to recording with a laser beam having a recording power Po of 35 mW or lower.

A high-sensitivity identification flag of “1” identifies the farther layer structure L1 as a highly-sensitive film-laminated layer structure.

In contrast, a high-sensitivity identification flag of “0” identifies the farther layer structure L1 as a normally-sensitive film-laminated layer structure that is available to recording with a recording power Po over 35 mW.

The high-sensitivity identification flag of “1” is stored in the lead-in area 23b of the highly-sensitive optical storage medium Dh for use in recording with the high-sensitivity optical recording apparatus.

The high-sensitivity identification flag of “0” is stored in the lead-in area 23b of the normally-sensitive optical storage medium Dl for use in recording with the normal-sensitivity optical recording apparatus.

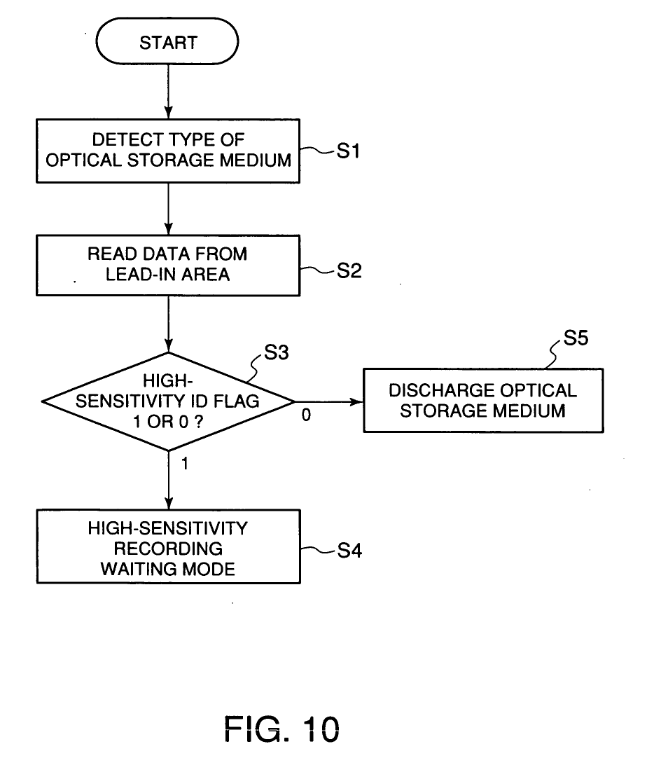

Shown in FIG. 10 is a flow chart of an operation mode of the high-sensitivity optical recording apparatus that starts when the optical storage medium D is installed, according to the present invention.

The high-sensitivity optical recording apparatus is a variation to the optical recording apparatus shown in FIG. 1. The detailed explanation of operation made with respect to FIG. 1 is also applied to the high-sensitivity optical recording apparatus.

The operation mode of the high-sensitivity optical recording apparatus shown in FIG. 10 is as follows:

In step S1, the type of the optical storage medium D is detected by the reflectivity detector 46 as to whether it is a read-only type, a rewritable type, a singe-layer type, a dual-layer type, etc.

In step S2, several kinds of data are read from the lead-in area 23b of the optical storage medium D by the reproducer (the optical head 34 with the LD 33 and the quadrant photo-detector, and the signal generator 57).

In step S3, it is determined by the system controller 45 that the high-sensitivity identification (ID) flag involved in the read-out data is “1” or “0”, or the installed medium D is the highly-sensitive optical storage medium Dh or the normally-sensitive optical storage medium Dl.

If the high-sensitivity identification flag is “1” in step S3, the high-sensitivity optical recording apparatus goes into a high-sensitivity recording waiting mode in step S4 under control by the system controller 45, for the high-sensitivity recording method with a recording laser power Po of 35 mW or lower to the farther layer structure L1.

On the contrary, if the high-sensitivity identification flag is “0” in step S3, the high-sensitivity optical recording apparatus discharges the optical storage medium D in step S5 under control by the system controller 45.

As disclosed, the high-sensitivity optical recording apparatus performs recording to the highly-sensitive optical storage medium Dh with the high-sensitivity optical recording method whereas discharges the normally-sensitive optical storage medium Dl with no recording performed.

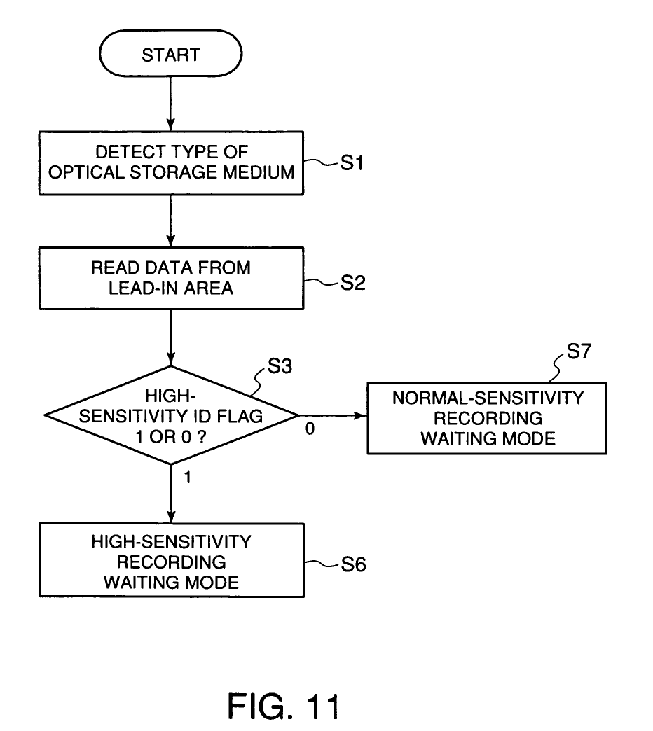

Shown in FIG. 11 is a flow chart of an operation mode of a normal-sensitivity optical recording apparatus that employs the normal-sensitivity optical recording method only. The operation mode starts when the optical storage medium D is installed.

This normal-sensitivity optical recording apparatus is another variation to the optical recording apparatus shown in FIG. 1. The detailed explanation of operation made with respect to FIG. 1 is also applied to the normal-sensitivity optical recording apparatus.

The operation mode of the normal-sensitivity optical recording apparatus shown in FIG. 11 is as follows:

The steps S1 to S3 are the same as those shown in FIG. 10 and hence not explained.

If the high-sensitivity identification flag is “1” in step S3, the normal-sensitivity optical recording apparatus discharges the optical storage medium D in step S6 under control by the system controller 45.

On the contrary, if the high-sensitivity identification flag is “0” in step S3, the normal-sensitivity optical recording apparatus goes into a normal-sensitivity recording waiting mode in step S7 under control by the system controller 45, for the normal-sensitivity recording method with a recording laser power over 35 mW to the farther layer structure L1.

As disclosed, the normal-sensitivity optical recording apparatus that employs only the normal-sensitivity optical recording method performs recording to the normal-sensitive optical storage medium Dl with the normal-sensitivity optical recording method whereas discharges the highly-sensitive optical storage medium Dh with no recording performed.

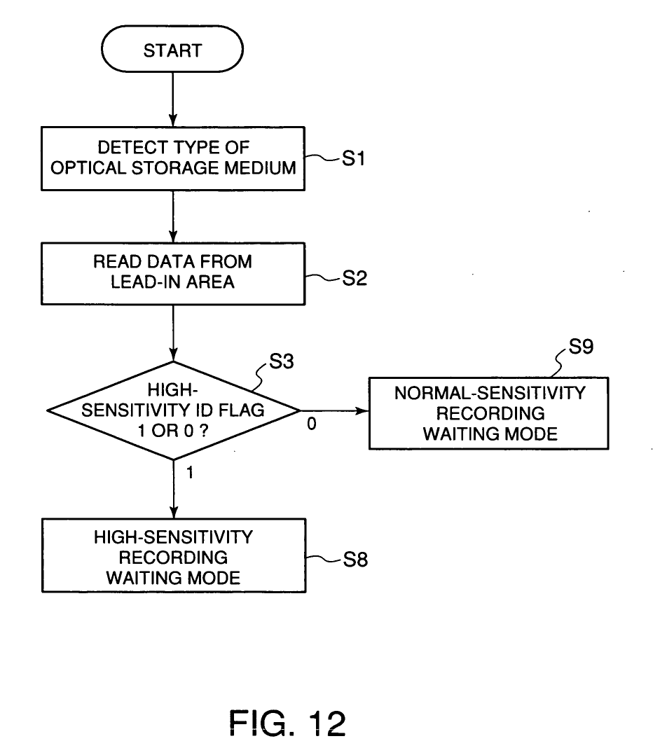

Shown in FIG. 12 is a flow chart of an operation mode of a normal-sensitivity optical recording apparatus that employs both of the normal- and high-sensitivity optical recording methods. The operation mode starts when the optical storage medium D is installed.

This normal-sensitivity optical recording apparatus is still another variation to the optical recording apparatus shown in FIG. 1. The detailed explanation of operation made with respect to FIG. 1 is also applied to the normal-sensitivity optical recording apparatus.

The operation mode of the normal-sensitivity optical recording apparatus shown in FIG. 12 is as follows:

The steps S1 to S3 are the same as those shown in FIG. 10 and hence not explained.

If the high-sensitivity identification flag is “1” in step S3, the normal-sensitivity optical recording apparatus goes into a high-sensitivity recording waiting mode in step S8 under control by the system controller 45.

On the contrary, if the high-sensitivity identification flag is “0” in step S3, the normal-sensitivity optical recording apparatus goes into a normal-sensitivity recording waiting mode in step S9 under control by the system controller 45.

The normal-sensitivity optical recording apparatus that employs both of the normal- and high-sensitivity optical recording methods is capable of recording to both of the normally- and highly-sensitive optical storage media Dl and Dh.

When the optical storage medium D is discharged in step S5 (FIG. 10) or step S6 (FIG. 11), a visual or an audio statement indicating that the medium D is not available for recording may be output. Such visual or audio statement may be recorded in the medium D or the optical recording apparatus.

Using the high-sensitivity identification flag of “1” or “0” stored in the lead-in area 23b of the optical storage medium D has several advantages as follows:

The highly-sensitive optical storage medium Dh is protected from being irradiated with a laser beam of a large recording power when installed in the normal-sensitivity optical recording apparatus that employs the normal-sensitivity optical recording method only.

In contrast, the normally-sensitive optical storage medium Dl is protected from being subjected to the high-sensitivity recording method when installed in the high-sensitivity optical recording apparatus.

As disclosed above, the present invention achieves excellent recording with a smaller laser power to the farther layer structure L1.

What is claimed is:

1. An optical recording apparatus comprising:
a reproducer to read out first identification data and second identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating first recording requirements to the first film-laminated layer structure, and the second identification data indicating second recording requirements to the second film-laminated layer structure, the first and second recording requirements being different from each other;
an encoder to modulate given data to be recorded into modulated data;
a recording signal generator to generate a data-recording signal having at least one mark followed by a space, based on the modulated data, the mark having a mark length nT (“T” being a unit clock cycle, and “n” being a positive integer of 3 or larger but 14 or smaller);
a controller to control recording as to whether to record the data to be recorded to the first or the second film-laminated layer structure based on the read-out identification data;
a recording pulse sequence generator to generate a first recording pulse sequence based on the first recording requirements when the controller controls recording so that the data is recorded to the first film-laminated layer structure whereas to generate a second recording pulse sequence based on the second recording requirements when the controller controls recording so that the data is recorded to the second film-laminated layer structure, the first recording pulse sequence having an (n−1)-number of recording pulses with a recording power corresponding to the mark length nT and additional pulses with a recording power that are generated for a period of the space and follow the recording pulses, and the second recording pulse sequence having an n/2-number of recording pulses with a recording power corresponding to the mark length nT when “n” is an even number whereas having an (n−1)/2-number of recording pulses with a recording power corresponding to the mark length nT when “n” is an odd number; and
a recorder to record the data to the first and second film-laminated layer structures with the light beam driven with the first and second recording pulse sequences, respectively.

2. An optical recording apparatus comprising:
a reproducer to read out first identification data, second identification data and third identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating first recording requirements to the first film-laminated layer structure, the second identification data indicating second recording requirements to the second film-laminated layer structure, and the third identification data indicating third recording requirements to the second film-laminated layer structure, the first, second and third recording requirements being different from one another;
an encoder to modulate given data to be recorded into modulated data;
a recording signal generator to generate a data-recording signal having at least one mark followed by a space, based on the modulated data, the mark having a mark length nT (“T” being a unit clock cycle, and “n” being a positive integer of 3 or larger but 14 or smaller);
a controller to control recording as to whether to record the data to be recorded to the first or the second film-laminated layer structure based on the read-out identification data;
a recording pulse sequence generator to generate a first recording pulse sequence based on the first recording requirements when the controller controls recording so that the data is recorded to the first film-laminated layer structure whereas to generate the first recording pulse sequence or a third recording pulse sequence based on the third recording requirements, with no reference to the second recording requirements, when the controller controls recording so that the data is recorded to the second film-laminated layer structure, the first recording pulse sequence having an (n−1)-number of recording pulses with a recording power corresponding to the mark length nT and additional pulses with a recording power that are generated for a period of the space and follow the recording pulses, and the third recording pulse sequence having the (n−1)-number of recording pulses with a recording power corresponding to the mark length nT; and
a recorder to record the data to the first film-laminated layer structure with the light beam driven with the first recording pulse sequence and to the second film-laminated layer structure with the light beam driven with the first or the third recording pulse sequence.

3. An optical recording method comprising the steps of:
reading out first identification data and second identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating first recording requirements to the first film-laminated layer structure, and the second identification data indicating second recording requirements to the second film-laminated layer structure, the first and second recording requirements being different from each other;
modulating given data to be recorded into modulated data;
generating a data-recording signal having at least one mark followed by a space, based on the modulated data, the mark having a mark length nT (“T” being a unit clock cycle, and “n” being a positive integer of 3 or larger but 14 or smaller);
controlling recording as to whether to record the data to be recorded to the first or the second film-laminated layer structure based on the read-out identification data;
generating a first recording pulse sequence based on the first recording requirements when recording is controlled so that the data is recorded to the first film-laminated layer structure whereas generating a second recording pulse sequence based on the second recording requirements when recording is controlled so that the data is recorded to the second film-laminated layer structure, the first recording pulse sequence having an (n−1)-number of recording pulses with a recording power corresponding to the mark length nT and additional pulses with a recording power that are generated for a period of the space and follow the recording pulses, and the second recording pulse sequence having an n/2-number of recording pulses with a recording power corresponding to the mark length nT when “n” is an even number whereas having an (n−1)/2-number of recording pulses with a recording power corresponding to the mark length nT when “n” is an odd number; and
recording the data to the first and second film-laminated layer structures with the light beam driven with the first and second recording pulse sequences, respectively.

4. An optical recording method comprising the steps of:
reading out first identification data, second identification data and third identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating first recording requirements to the first film-laminated layer structure, the second identification data indicating second recording requirements to the second film-laminated layer structure, and the third identification data indicating third recording requirements to the second film-laminated layer structure, the first, second and third recording requirements being different from one another;
modulating given data to be recorded into modulated data;
generating a data-recording signal having at least one mark followed by a space, based on the modulated data, the mark having a mark length nT (“T” being a unit clock cycle, and “n” being a positive integer of 3 or larger but 14 or smaller);
controlling recording as to whether to record the data to be recorded to the first or the second film-laminated layer structure based on the read-out identification data;
generating a first recording pulse sequence based on the first recording requirements when recording is controlled so that the data is recorded to the first film-laminated layer structure whereas generating the first recording pulse sequence or a third recording pulse sequence based on the third recording requirements, with no reference to the second recording requirements, when recording is controlled so that the data is recorded to the second film-laminated layer structure, the first recording pulse sequence having an (n−1)-number of recording pulses with a recording power corresponding to the mark length nT and additional pulses with a recording power that are generated for a period of the space and follow the recording pulses, and the third recording pulse sequence having the (n−1)-number of recording pulses with a recording power corresponding to the mark length nT; and
recording the data to the first film-laminated layer structure with the light beam driven with the first recording pulse sequence and to the second film-laminated layer structure with the light beam driven with the first or the third recording pulse sequence.

5. A phase-change optical storage medium comprising:
a light-incident surface through which a light beam is to be incident;
at least a first film-laminated layer structure and a second film-laminated layer structure provided over the surface in which the first film-laminated layer structure is provided as closer to the light-incident surface than the second film-laminated layer structure is, each film-laminated layer structure having at least a recording film; and
a storing area for physically storing first identification data indicating a first recording pulse sequence to be used in recording to the first film-laminated layer structure and second identification data indicating a second recording pulse sequence to be used in recording to the second film-laminated layer structure, the first recording pulse sequence having an (n−1)-number of recording pulses with a recording power corresponding to a mark length nT of a data-recording signal having at least one mark followed by a space, based on data to be stored, the mark having a mark length nT (“T” being a unit clock cycle, and “n” being a positive integer of 3 or larger but 14 or smaller) and additional pulses with a recording power that are generated for a period of the space and follow the recording pulses, and the second recording pulse sequence having an n/2-number of recording pulses with a recording power corresponding to the mark length nT when “n” is an even number whereas having an (n−1)/2-number of recording pulses with a recording power corresponding to the mark length nT when “n” is an odd number.

6. The phase-change optical storage medium according to claim 5, wherein the storing area physically stores third identification data indicating the first recording pulse sequence or a third recording pulse sequence to be used in recording to the second film-laminated layer structure, the third recording pulse sequence having the (n−1)-number of recording pulses with a recording power corresponding to the mark length nT.

7. The phase-change optical storage medium according to claim 5, wherein the storing area is a lead-in area.

8. An optical recording apparatus comprising:
a reproducer to determine whether identification data is stored in a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the identification data indicating the optimum recording power of 35 mW or smaller to the second film-laminated layer structure, and read out the identification data if stored; and
a controller to control recording to the phase-change optical storage medium so that data is recorded to the optical storage medium with the light beam driven with a power of 35 mW or smaller to the second film-laminated layer structure if the identification data is read out whereas the data is not recorded to the optical storage medium if the identification data is not stored.

9. An optical recording apparatus comprising:
a reproducer to read out first identification data or second identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating a first power of 35 mW or smaller as the optimum recording power to the second film-laminated layer structure, and the second identification data indicating a second power over 35 mW as the optimum recording power to the second film-laminated layer structure; and
a controller to control recording to the phase-change optical storage medium so that data is recorded to the optical storage medium with the light beam driven with the first power to the second film-laminated layer structure if the first identification data is read out whereas with the second power to the second film-laminated layer structure if the second identification data is read out.

10. An optical recording method comprising the steps of:
determining whether identification data is stored in a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the identification data indicating the optimum recording power of 35 mW or smaller to the second film-laminated layer structure, and reading out the identification data if stored; and
controlling recording to the phase-change optical storage medium so that data is recorded to the optical storage medium with the light beam driven with a power of 35 mW or smaller to the second film-laminated layer structure if the identification data is read out whereas the data is not recorded to the optical storage medium if the identification data is not stored.

11. An optical recording method comprising the steps of:
reading out first identification data or second identification data from a phase-change optical storage medium having a light-incident surface through which a light beam is to be incident and at least a first film-laminated layer structure and a second film-laminated layer structure provided over the light-incident surface in which the first film-laminated layer structure is provided as closer to the light-incident surface than the second film-laminated layer structure is, each film-laminated layer structure having at least a recording film, the first identification data indicating a first power of 35 mW or smaller as the optimum recording power to the second film-laminated layer structure, and the second identification data indicating a second power over 35 mW as the optimum recording power to the second film-laminated layer structure; and
controlling recording to the phase-change optical storage medium so that data is recorded to the optical storage medium with the light beam driven with the first power to the second film-laminated layer structure if the first identification data is read out whereas with the second power to the second film-laminated layer structure if the second identification data is read out.

12. An phase-change optical storage medium comprising:
a light-incident surface through which a light beam is to be incident;
at least a first film-laminated layer structure and a second film-laminated layer structure provided over the surface in which the first film-laminated layer structure is provided as closer to the light-incident surface than the second film-laminated layer structure is, each film-laminated layer structure having at least a recording film; and
a storing area for physically storing identification data indicating that the second film-laminated layer structure is available to recording with a recording power of 35 mW or smaller that is the optimum recording power to the second film-laminated layer structure.
